(19) United States
(12) Patent Application Publication
(10) Pub. No.: US 2014/0302360 A1
(43) Pub. Date: Oct. 9, 2014

(54) ELECTRICAL ENERGY ACCUMULATOR

(71) Applicant: AVL LIST GMBH, Graz (AT)

(72) Inventors: Kurt Klammler, Fladnitz (AT); Martin Michelitsch, Kumberg (AT); Harald Stuetz, Semriach (AT); Dietmar Niederl, Jagerberg (AT); Oliver Urem, Bruck/Mur (AT)

(21) Appl. No.: 14/351,409

(22) PCT Filed: Oct. 11, 2012
(86) PCT No.: PCT/EP2012/070191

§ 371 Date: Apr. 11, 2014

(30) Foreign Application Priority Data
Oct. 13, 2011 (AT) A 1485/2011

(51) Int. Cl. H01M 2/10; H01M 2/20; H01M 10/625

(52) U.S. Cl. CPC H01M 2/1077; H01M 10/5016; H01M 2/20
USPC 429/72; 429/158; 429/120; 29/623.1

(57) ABSTRACT

An electrical energy accumulator and a method for manufacturing an electrical energy accumulator. Such an electrical energy accumulator, in particular, for an electric vehicle, has a plurality of battery cells which are electrically connected to one another. The battery cells are, in particular, flat and essentially plate-shaped, and are arranged in at least one stack adjacent to one another or one on top of another. The cell poles of at least two battery cells which are electrically interconnected to one another are connected to one another by at least one cell connector. At least one cell pole and at least one cell connector are connected to one another in particular by way of a clinching connection.

### CROSS-REFERENCE TO RELATED APPLICATIONS

The present application is a National Stage Application of PCT International Application No. PCT/EP2012/070191 (filed on Oct. 11, 2012), under 35 U.S.C. §371, which claims priority to Austrian Patent Application No. A 1485/2011 (filed on Oct. 13, 2011), which are each hereby incorporated by reference in their respective entireties.

### TECHNICAL FIELD

Embodiments relate to an electrical energy accumulator and a method for manufacturing an electrical energy accumulator.

### BACKGROUND

A battery having a plurality of flat, essentially plate-shaped battery single cells is known from German Patent Publication No. DE 10 2009 035463 A1. The battery single cells are stacked into a cell stack and are enclosed using a battery housing. The battery single cells are implemented in the frame flat construction having metallic sheets and a frame made of insulating material.

A battery module having a plurality of plate-shaped battery cells arranged adjacent to one another in a stack, which are housed in a housing, is also known from WO 2008/048751 A2.

WO 2010/053689 A2 describes a battery arrangement having a housing and a plurality of lithium-ion cells, which are arranged adjacent to one another. A thermally conductive, electrically insulating fluid flows through the housing for cooling.

European Patent Publication No. EP 1 530 247 A2 describes a battery having multiple stacks of battery cells stacked on one another, wherein respectively two adjacent battery cells of a stack having alternating polarities are arranged on one another and are electrically connected in series in a serpentine manner. Each stack is furthermore electrically connected in series to the adjacent stack. It is disadvantageous that many individual steps are necessary for the assembly and the production of the electrical connections and many individual parts are necessary for the battery.

WO 2010/053689 A2 describes a battery arrangement having a housing and a plurality of lithium-ion cells, which are arranged adjacent to one another. A thermally conductive, electrically insulating fluid flows through the housing for cooling.

WO 2011/144 372 A1 describes a lithium-ion battery cell and a method for producing an electrically conductive contact of terminals of battery cells, wherein the terminals are connected to one another to form electrically conductive contacts using a joining method, for example, a clinching method.

A method for connecting a battery pole of a first battery cell to a battery pole of a second battery cell is known from German Patent Publication No. DE 10 2009 046 505 A1, wherein the battery poles are connected in a friction-locked and formfitting manner by way of joggling, clinching or toxing to produce the electrically conductive contact.

Clinched connections require the free access for a pliers-type clinching tool. The parts to be clinched must be exposed on both sides, to allow unobstructed access and movement of the clinching tool. Clinched connections have the advantage that no heat is introduced into the parts to be connected. However, it is disadvantageous that a relatively large amount of processing space must be provided for the clinching method. Parts connected by way of clinching sometimes form a protruding edge, which elevates the dimensions of the component and additionally makes contact cooling by way of a cooling body more difficult.

Batteries having a plurality of cylindrical single cells arranged adjacent to one another, which are connected in a heat conductive manner using heat conduction plates, and also are fastened thereon on the top and/or bottom side, are known from German Patent Publication Nos. DE 10 2009 035 458 A1 and DE 10 2008 059 947 A1. The heat conduction plate respectively has recesses at the pole contacts.

German Patent Publication No. DE 10 2007 063 178 B4 describes a battery having a battery housing and the heat conduction plate for temperature control of the battery, wherein the battery has multiple single cells connected in parallel and/or in series, which are connected in a heat conductive manner to the conduction plate, wherein the heat conduction plate has boreholes and/or notches in the region of the poles of the single cells, into or through which the poles protrude. The heat conduction plate is arranged on a single side of single cells, wherein the single cells are respectively fastened to the heat conduction plate via the associated poles by way of a pre-tensioned connection of fastening elements, which are arranged in or on the poles in a formfitting or friction-locked manner.

WO 2011/145 542 A1 discloses an energy accumulator having three stacks of battery cells, which are arranged adjacent to one another with alternating polarities of the cell poles, and which are electrically connected in series in a serpentine manner.

Japanese Patent Publication No. JP 2010/113 888 A1 discloses an energy accumulator having two stacks of battery cells, which are arranged adjacent to one another with alternating polarities of the cell poles, wherein the stacks are held together via compression plates.

Furthermore, an energy accumulator having stackable single cells, which are electrically connected in series in a serpentine manner spanning the stacks, is known from European Patent Publication No. EP 2 144 324 A1.

The known heat conduction units are relatively complex to produce.

### SUMMARY

The object of the invention is to provide a compact energy accumulator with low manufacturing and assembly expenditure.

This is achieved in accordance with embodiments in that at least the cell pole connected to the cell connector, preferably by the clinching connection, for example, a clinch connection, is bent over in a first plane perpendicularly to the cell plane of the battery cells.

A very compact energy accumulator is achieved, if respectively two adjacent battery cells have cell planes arranged essentially parallel to one another and are stacked having alternating polarities of the cell poles, wherein at least two stacks of battery cells are arranged adjacent to one another, and wherein respectively one battery cell of a first stack and one battery cell of a second stack are arranged in a shared cell plane and are electrically connected in series.

It is preferably provided that unlike cell poles of each two adjacent battery cells, which are arranged in a cell plane, of adjacent stacks face toward one another.

It is particularly advantageous if the at least one first group of battery cells, which are arranged in a first cell plane, is electrically connected in series to at least one second group of battery cells, which are arranged in a second cell plane, wherein the second cell plane is arranged in parallel to the first cell plane, preferably adjacent thereto.

At least one first stack and at least one second stack of battery cells can form a joint battery module, wherein preferably the battery cells of stacks arranged in the joint battery module are arranged between two respective compression plates (end plates) which are shared for the stack. At least two adjacent battery modules can be electrically interconnected to one another within the electrical energy accumulator.

It is preferably provided that each battery cell includes at least two base cells connected in parallel. Each battery cell can therefore have a parallel circuit of two base cells arranged within a pouch cell, for example (2p circuit). In a similar manner, 3p and 4p circuits of base cells can also be implemented for the battery cells, wherein three or four or base cells, respectively, are connected in parallel.

The interconnection of the cells therefore not only occurs within a single stack, i.e., along the stack, but rather also occurs in a serpentine manner transversely going back and forth between two adjacent stacks. This type of the circuit order has the advantage that the cell poles of the battery cells implemented as pouch cells, for example, can firstly be aligned perpendicularly to one another during the assembly, in order to be connected directly to one another, for example, using the method of clinching or via cell connectors. The cell poles can then be turned, bent, or aligned in a specific predefined direction (identical for all cell poles).

Particularly simple manufacturing is made possible if a first cell connector and a second cell connector are connected to one another, preferably by a clinching connection, to connect at least two battery cells of a stack arranged one on top of another along the stack direction, wherein the first cell connector is connected to a cell pole of one battery cell and the second cell connector is connected to a cell pole of an adjacent battery cell, preferably respectively by a further clinching connection. It can similarly be provided that a second cell connector and a third cell connector are connected to one another, preferably by a clinching connection, to connect at least two stacks of battery cells arranged one on top of another along the stacking direction, wherein the second cell connector is connected to a cell pole of one stack and the third cell connector is connected to a cell pole of the adjacent stack, preferably respectively by a further clinching connection. It is particularly favorable for the automated production of the clinching connections if, when considered in the stacking direction, at least one cell connector, preferably the first, the second, and/or the third cell connector, has a first L-shape—particularly preferably formed by a bending operation. Furthermore, at least one cell connector, preferably the first and/or third cell connector, can also, considered transversely to the stack direction, preferably in a top view of the energy accumulator, have a second L-shape, wherein particularly preferably the second L-shape has two legs arranged in a plane.

Furthermore, a fourth cell connector, preferably implemented as flat, can preferably be connected by a clinching connection to a cell pole of the battery cell of one stack and preferably by a further clinching connection to a cell pole of the battery cell of an adjacent stack to connect at least two battery cells arranged adjacent to one another transversely to the stack direction.

For the electrical connection of at least two battery cells of a stack, which are arranged one on top of another along the stack direction, a first leg of an L-shaped first cell connector is connected to a cell pole of one battery cell and a first leg of an L-shaped second cell connector is connected to a cell pole of an adjacent battery cell, preferably by a clinching connection, wherein before the clinching operation, the cell poles and the first legs are aligned parallel to the cell planes and at least partially overlapping one another. The cell poles together with the cell connectors are then bent over in the same direction by approximately 90° into a plane perpendicular to the cell planes, so that the second legs of the first and second cell connectors overlap one another. Finally, the second legs of the first and second cell connectors, which protrude vertically upward perpendicularly to the cell plane, are connected to one another, preferably by a further clinching connection.

Similarly thereto, for the electrical connection of at least two battery modules of battery cells, which are arranged one behind another along the stack direction, a first leg of an L-shaped third cell connector is connected to a cell pole of one battery module and a first leg of an L-shaped second cell connector is connected to a cell pole of an adjacent module, preferably by a clinching connection, wherein before the clinching operation, the cell poles and the first legs are aligned parallel to the cell planes and at least partially overlapping one another. The cell poles together with the cell connectors are then bent over in the same direction by approximately 90° into a plane perpendicular to the cell planes so that the second legs of the third and second cell connectors overlap one another. Finally, the second legs of the third and second cell connectors, which protrude vertically upward from the battery cells in a perpendicular plane to the cell planes, are preferably connected to one another by a further clinching connection.

To connect at least two battery cells arranged adjacent to one another transversely to the stack direction, a fourth cell connector, preferably implemented as flat, is preferably connected by a clinching connection to a cell pole of the battery cell of one stack and preferably by a further clinching connection to a cell pole of the battery cell of an adjacent stack, wherein before the clinching operation, the cell poles and the fourth cell connectors are aligned parallel to the cell planes and at least partially overlapping one another. After the clinching operation, the cell poles together with the fourth cell connectors are bent over in the same direction by approximately 90° into a plane perpendicular to the cell planes.

All cell poles together with the cell connectors connected thereto are therefore bent over in the same direction, preferably along the stack direction, so that the top sides of bent-over cell connectors essentially form contact surfaces arranged in a plane parallel to the stack direction. At least one heat conduction unit is placed on the contact surfaces formed by the bent-over cell connectors and is preferably connected to the cell connectors thermally and fixedly, particularly preferably by gluing.

The heat conduction unit has at least one heat conduction surface, which faces toward the battery cells and is preferably implemented as flat and parallel to the contact plane, wherein the heat conduction surface is thermally and fixedly connected to the cell connectors. It is preferably provided that the heat conduction surfaces, which are preferably implemented as flat, are arranged in a shared plane.

The best possible temperature control of the electrical energy accumulator can thus be achieved in a manner which is simple to manufacture.

In a first embodiment variant, it can be provided that the heat conduction unit has at least two channels, preferably at least four channels, through which the heat conduction medium flows, transversely to the battery cells, particularly preferably perpendicularly to the cell planes of the battery cells.

To allow a good thermal connection between the contact points and the heat conduction unit, it is advantageous if the heat conduction unit is glued using its heat conduction surface on the contact points. Additionally or alternatively thereto, the heat conduction unit can also be removably fastened, for example, using screws, on the battery module. It can be provided, for example, that the heat conduction unit has, between at least two channels, a fastening region for a fastening means preferably formed by fastening screws.

The channels can have an essentially constant cross section between the entry region and the exit region for the heat conduction medium. Alternatively thereto, it is also conceivable to implement the channels having different cross-sectional profiles, to achieve optimum cooling or heating of the battery cells for the respective case.

For uniform temperature control of the battery cells, it is advantageous if the entry region and the exit region are arranged on different end faces of the energy accumulator.

Larger energy accumulators have, depending on the application, multiple battery modules. It can be provided that the heat conduction unit is thermally connected to the contact points of at least two battery modules, which are arranged one behind another in the stack direction of the battery cells, and is designed for cooling or heating the two battery modules.

Simple manufacturing may be achieved if the heat conduction unit is fixedly, preferably inseparably, joined together from at least two parts, preferably a bottom shell and a top shell. The heat conduction unit can be manufactured from plastic or from metal, for example, steel or aluminum. The top shell and bottom shell of the heat conduction unit can be friction welded or connected to one another, for example, by another non-detachable joining method with application of heat and/or pressure, for example, by laser welding or gluing, so that a compact part results.

In a further particularly symbol embodiment in accordance with embodiments, it is provided that the heat conduction unit includes plastic and is preferably produced by an extrusion method. It is advantageous in this production method that subsequent connection of the top shell and the bottom shell of the heat conduction unit is omitted.

The attitude of the heat conduction unit can be produced vertically, horizontally, or at a specific angle thereto, depending on the alignment of the battery modules.

Alternatively to a shared heat conduction unit for all battery cells having multiple channels, a separate heat conduction unit having a single channel can also be provided for each channel, which extends transversely to the cell planes via contact points arranged one behind another in the stack direction. This heat conduction unit can be embodied in one piece and can be produced in an extrusion method.

### DRAWINGS

The invention will be explained in greater detail hereafter on the basis of the figures. In the figures:

FIG. 1 illustrates a battery module of an energy accumulator in accordance with embodiments in a diagonal view from above.

FIG. 2 illustrates detail II of the battery module from FIG. 1.

FIGS. 3 to 5 show the battery module in a front view during a clinching operation.

FIG. 6 illustrates a first cell connector in a diagonal view.

FIG. 7 illustrates a second cell connector in a diagonal view.

FIG. 8 illustrates a third cell connector in a diagonal view.

FIG. 9 illustrates a fourth cell connector.

FIG. 10 illustrates the battery module in a top view.

FIG. 11 illustrates the battery module including heat conduction unit in a side view.

FIG. 12 illustrates the energy accumulator including heat conduction unit in a front view.

FIG. 13 illustrates this energy accumulator in a top view.

FIG. 14 illustrates the energy accumulator in a diagonal view.

FIG. 15 illustrates a heat conduction unit in a diagonal view in a first embodiment variant.

FIG. 16 illustrates the heat conduction unit in a front view.

FIG. 17 illustrates the heat conduction unit in a section along line XVII-XVII in FIG. 16.

FIG. 18 illustrates a heat conduction in a diagonal view in a second embodiment variant.

FIG. 19 illustrates detail XIX from FIG. 18.

FIG. 20 illustrates the heat conduction unit from FIG. 18 in a front view.

FIG. 21 illustrates this heat conduction unit in a section along line XXI-XXI in FIG. 20.

FIG. 22 illustrates a heat conduction unit in a diagonal view in a third embodiment variant.

FIG. 23 illustrates detail XXIII from FIG. 22.

FIG. 24 illustrates the heat conduction unit from FIG. 22 in a front view;

FIG. 25 illustrates this heat conduction unit in a section along line XXV-XXV in FIG. 24.

FIG. 26 illustrates a heat conduction unit in a diagonal view in a fourth embodiment variant.

FIG. 27 illustrates this heat conduction unit in a top view.

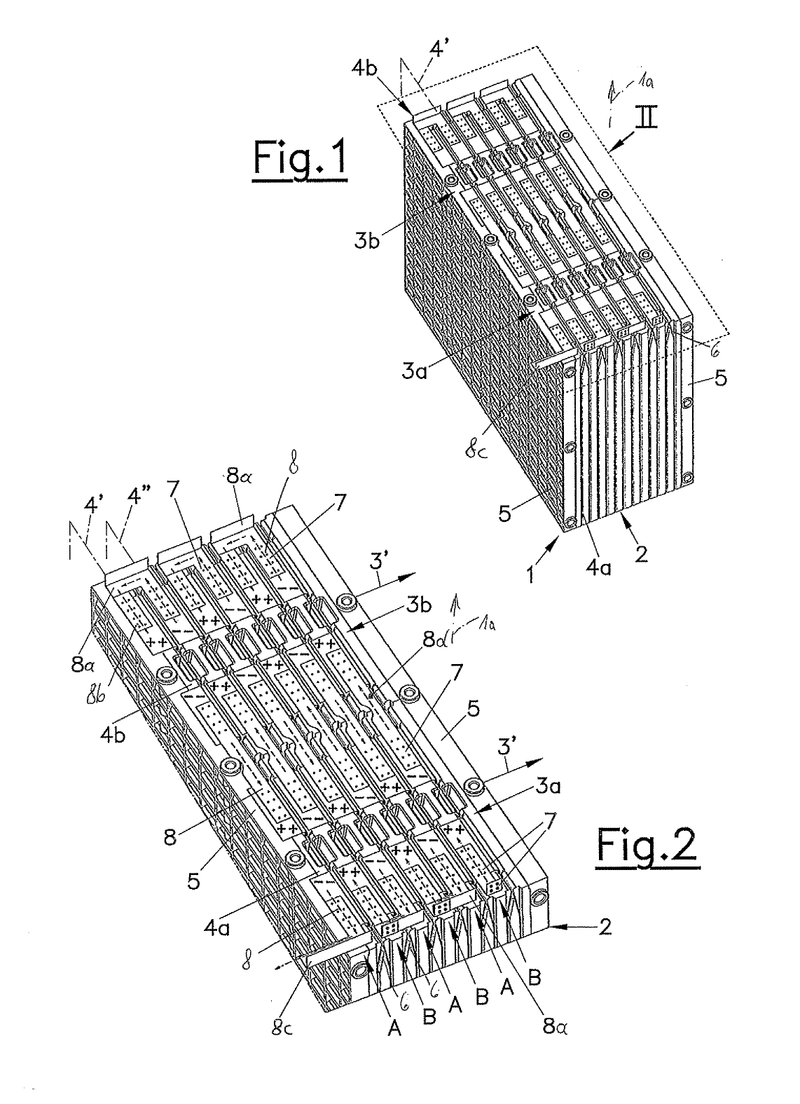

### DESCRIPTION

Functionally identical parts are provided with identical reference signs in the embodiment variants.

The energy accumulator 1 formed by a rechargeable battery has at least one battery module 2. Each battery module 2 has in the interior at least two stacks 3a, 3b of concatenated plate-shaped battery cells 4a, 4b (for example, pouch cells), which are pressed against one another by compression plates 5. Each battery cell 4a, 4b is implemented as a double cell, wherein a 2p circuit (parallel circuit of the cell poles 6 of two base cells) can be provided within a double cell.

Each two battery cells 4a and 4b, which are arranged one on top of another or adjacent to one another in the stack direction 3′, of each stack 3a or 3b, respectively, have cell planes 4′, 4″, which are arranged essentially parallel to one another, and are stacked with alternating polarities ++/−−. The cell planes 4′, 4″ are arranged parallel to the vertical axis 1a of the energy accumulator 1.

The two stacks 3a, 3b are arranged adjacent to one another, wherein respectively one battery cell 4a of a first stack 3a and one battery cell 4b of a second stack 3b are arranged in a shared cell plane 4′. Respectively two battery cells 4a, 4b, which are arranged adjacent to one another in a cell plate 4′, of adjacent stacks 3a, 3b are arranged oriented in the same direction (i.e., all cell poles 6 point in one direction), wherein unlike polarities “++” or “−−” of adjacent battery cells 4a, 4b face toward one another, and are electrically connected in series.

At least one first group A of battery cells 4a, 4b arranged in a first cell plane 4′ is electrically connected in series to at least one second group B of battery cells 4a, 4b arranged in an adjacent second cell plane 4″, wherein the second cell plane 4″ is arranged in parallel and adjacent to the first cell plane 4′.

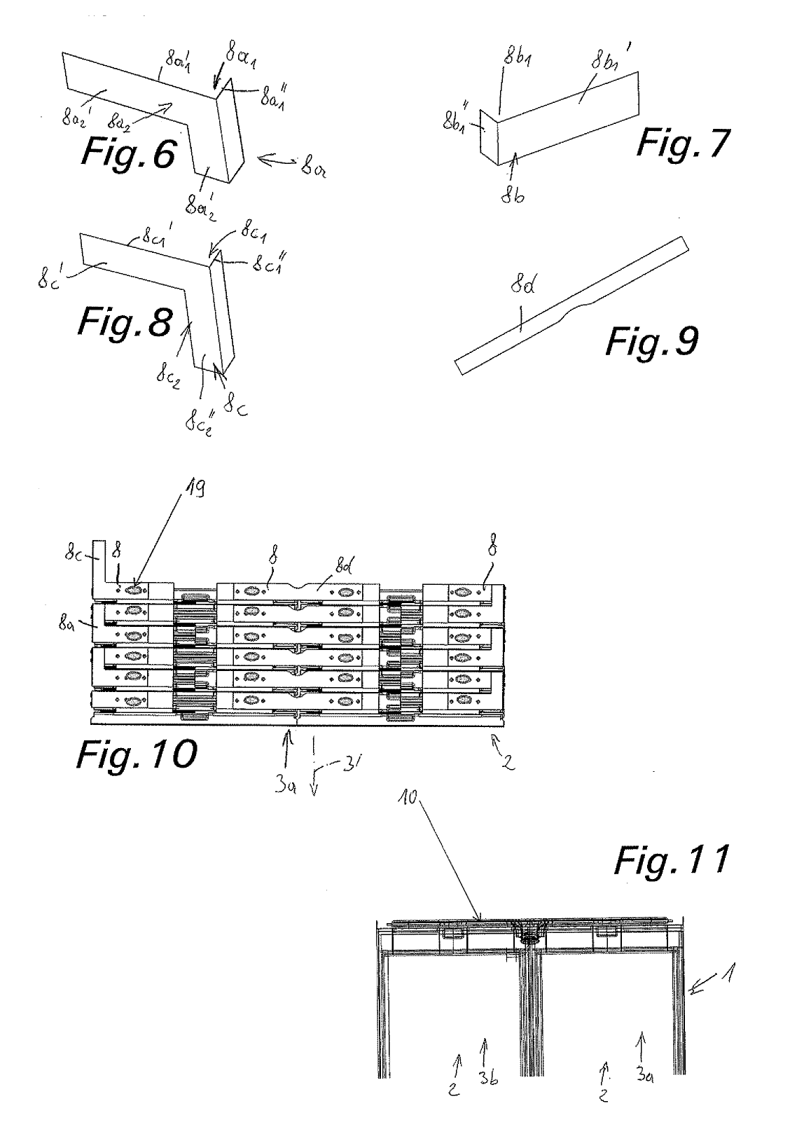

The energy accumulator 1 can have multiple battery modules 2, wherein adjacent battery modules 2 are electrically interconnected to one another in serial or in parallel via cell connectors 8a, 8b, 8c, 8d. Four different cell connectors 8a, 8b, 8c, 8d are used, which are illustrated in detail in FIGS. 6 to 9. At least one first stack 3a and at least one second stack 3b of battery cells 4a, 4b can be associated with a shared battery module 2.

The first cell connector 8a and the second cell connector 8b are used for the purpose of electrically connecting the cell poles 6 of two battery cells 4a, 4b, which are adjacent in the stack direction 3′, of a stack 3a, 3b to one another. Using third cell connectors 8c, in combination with second cell connectors 8b, respectively stacks 3a, 3b of battery cells 4a, 4b can be electrically connected to one another in the stack direction 3′. The first, second, and third cell connectors 8a, 8b, 8c respectively have a first L-shape 8a1, 8b1m, 8c1, which is formed by a bending operation, having a first and a second leg 8a1′, 8a1″, 8b1′, 8b1″ 8c1′, 8c1″. The first and third cell connectors 8a, 8c additionally also have a second L-shape 8a2, 8b2 having a first and a second leg 8a2′, 8a2″, 8c2′, 8c2″ arranged in a plane.

The fourth cell connectors 8d, which are implemented as essentially flat, are used to electrically connect battery cells 4a, 4b within a group A, B to one another.

The electrical connection of battery cells 4a, 4b interconnected to one another is advantageously performed by clinching connections 7, for example, clinched connections.

The interconnection of the battery cells 4a, 4b therefore does not occur within a single stack 3a, 3b, i.e., along the stack 3a, 3b, but rather is performed in a serpentine manner transversely going back and forth between two adjacent stacks 3a, 3b. This type of the circuit order has the advantage that the cell poles 6 of the polarities ++, −− of the pouch cells 4a, 4b can firstly be aligned perpendicularly during the assembly, to be able to be connected directly to one another or via cell connectors 8a, 8b, 8c, 8d using the method of clinching. The cell poles 6 can then be turned, bent, or aligned in a specific predefined direction (identical for all cell poles 6). It is thus possible, for example, to fix, for example, to glue a heat conduction unit 10 on the cell poles 6 of the battery cells 4a, 4b using the largest possible surface or the largest possible cross section.

In the exemplary embodiments, the invention is illustrated on the basis of 2p circuits, which are performed back and forth transversely between the two stacks 3a, 3b. It is similarly possible to implement so-called 3p or 4p circuits via two stacks 3a, 3b, in which instead of two adjacent base cells in a battery cell 4a, 4b of a stack 3a, three or four base cells are connected in parallel, wherein a serial connection is performed to the second stack 3b.

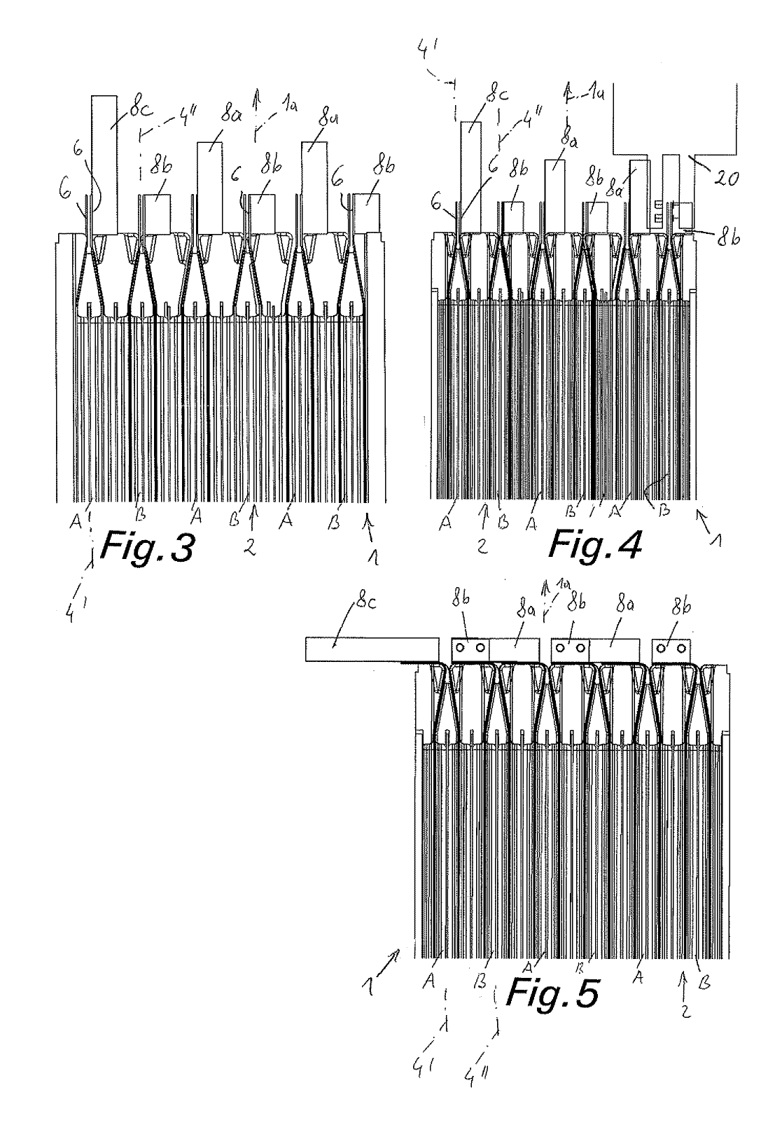

FIGS. 3 to 5 show the production of the clinching connections 7 in three phases. In the first step illustrated in FIG. 3, the cell poles 6 of respectively one double cell are bent toward one another and aligned in parallel to the vertical axis 1a of the energy accumulator 1. The cell connectors 8a, 8b, 8c, 8d are moved into the adjoining position, wherein the first legs 8a1′, 8b1′, 8c1′ of the first L-shapes 8a1, 8b1, 8c1 of the cell connectors 8a, 8b, 8c are arranged parallel to the cell planes 4′, 4″ and directly adjoining the respective cell pole 6 and the second legs 8a1″, 8b1″, 8c2″ are aligned parallel to the vertical axis 1a and the stack direction 3′. The fourth cell connectors 8d are aligned parallel to the cell plate 4′, 4″ directly adjacent to the respective cell poles 6 to be connected of different polarities ++/−− of two battery cells 4a, 4b of different stacks 3a, 3b.

In the second step illustrated in FIG. 4, the first legs 8a1′, 8b1′, 8c1′ of the first L shapes 8a1, 8b1, 8c1 of the cell connectors 8a, 8b, 8c and the fourth cell connector 8d are connected to the respective adjoining cell poles 6 using a clinching tool 20.

The cell connectors 8a, 8b, 8c, 8d together with the connected cell poles 6 are then bent over in the same direction in the stack direction 3′ by a bending angle of 90°, so that the first legs 8a1′, 8b1′, 8c1′, and also the second L-shape 8a2, are now folded into a perpendicular plane on the vertical axis 1a. By way of this folding-over movement, the second legs 8a1″ of the first L shape 8a1 come to rest overlapping adjacent to the second leg 8b1″ of the adjacent second cell connector 8b, wherein the second legs 8a1″ and 8b1″ are arranged parallel to the vertical axis 1a and parallel to the stack direction 3′. In a further step, the upwardly protruding second legs 8a1″ and 8b1″ are now connected to one another using the clinching tool 20.

Due to the bending over of the cell connectors 8a, 8b, 8c, 8d, the top sides thereof, and specifically the first legs 8a1′, 8b1′, 8c1′, of the first, second, and third cell connectors 8a, 8b, 8c, and also the top sides of the fourth cell connectors 8d, form flat contact surfaces 8, which are arranged perpendicularly to the cell planes 4′, 4″, and parallel to the stack direction 3′ or perpendicularly to the vertical axis 1a. The contact surfaces 8 are located essentially in the same plane ε.

The contact surfaces 8 are used to accommodate at least one essentially plate-shaped heat conduction unit 10 placed on the battery cells 4a, 4b.

The heat conduction unit 10 is used for cooling or heating the battery cells 4a, 4b, wherein the heat conduction unit 10 is fixedly connected to the battery cells 4a, 4b using one or more essentially flat heat conduction surfaces 14 in the region of the contact surfaces 8.

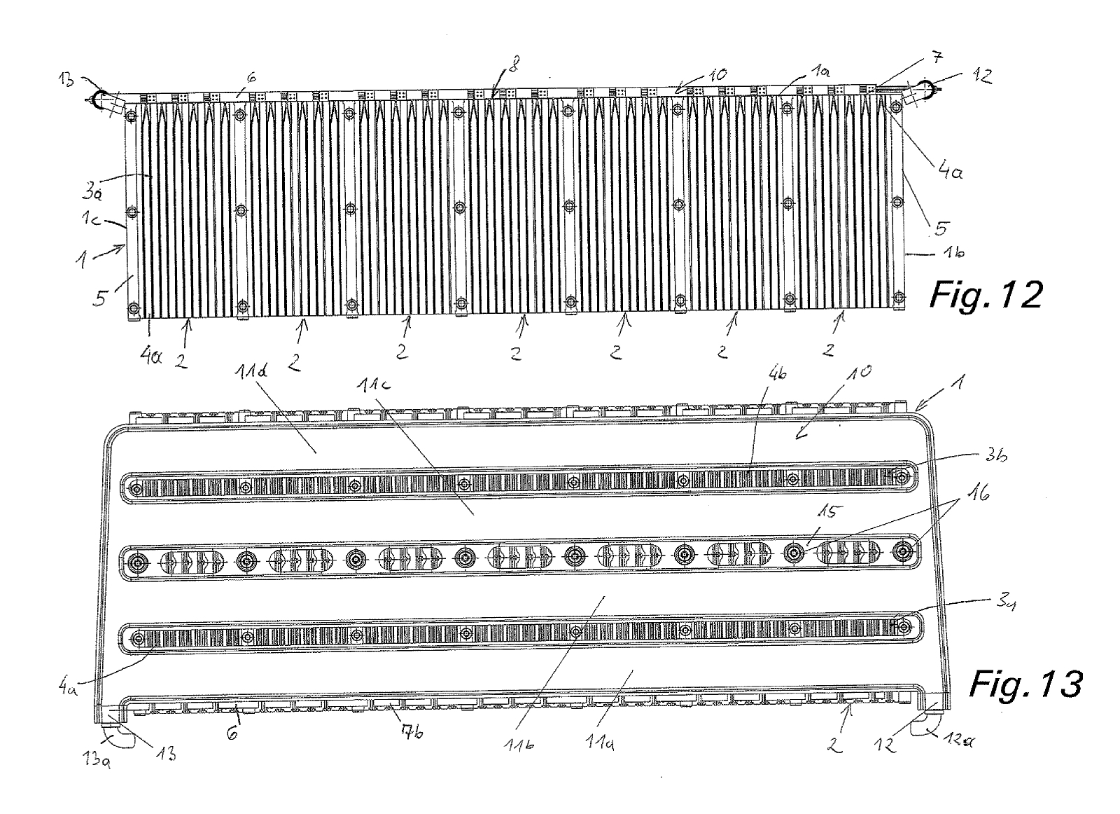

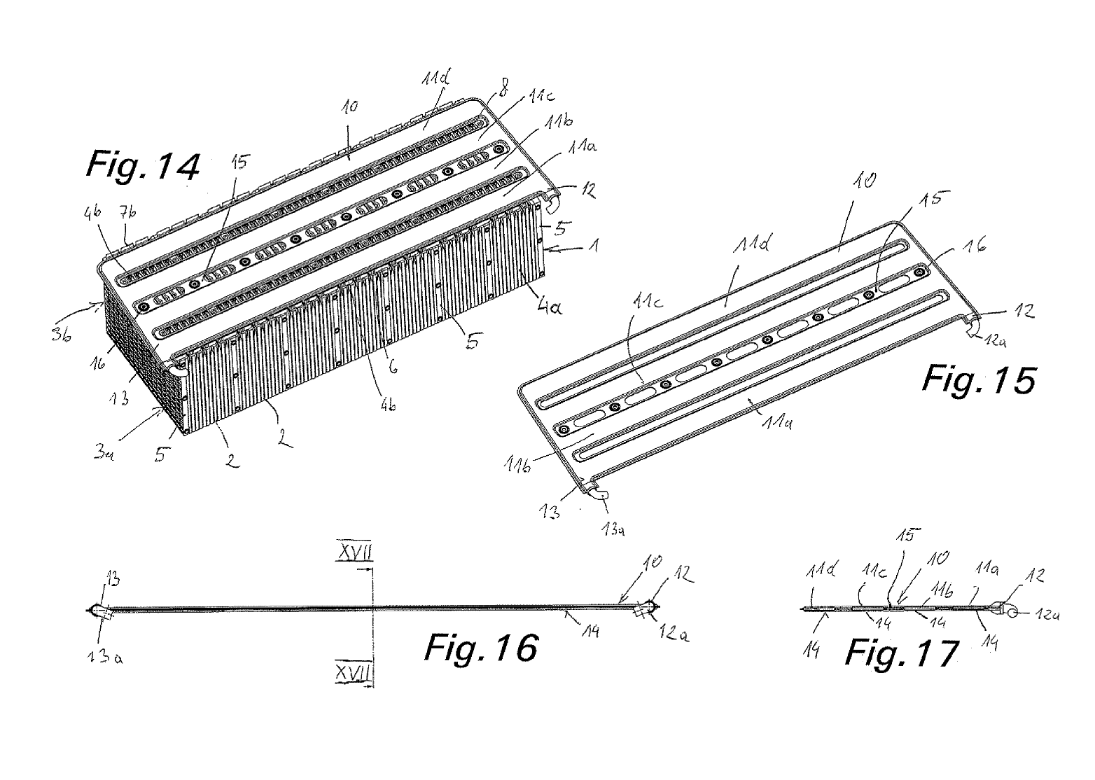

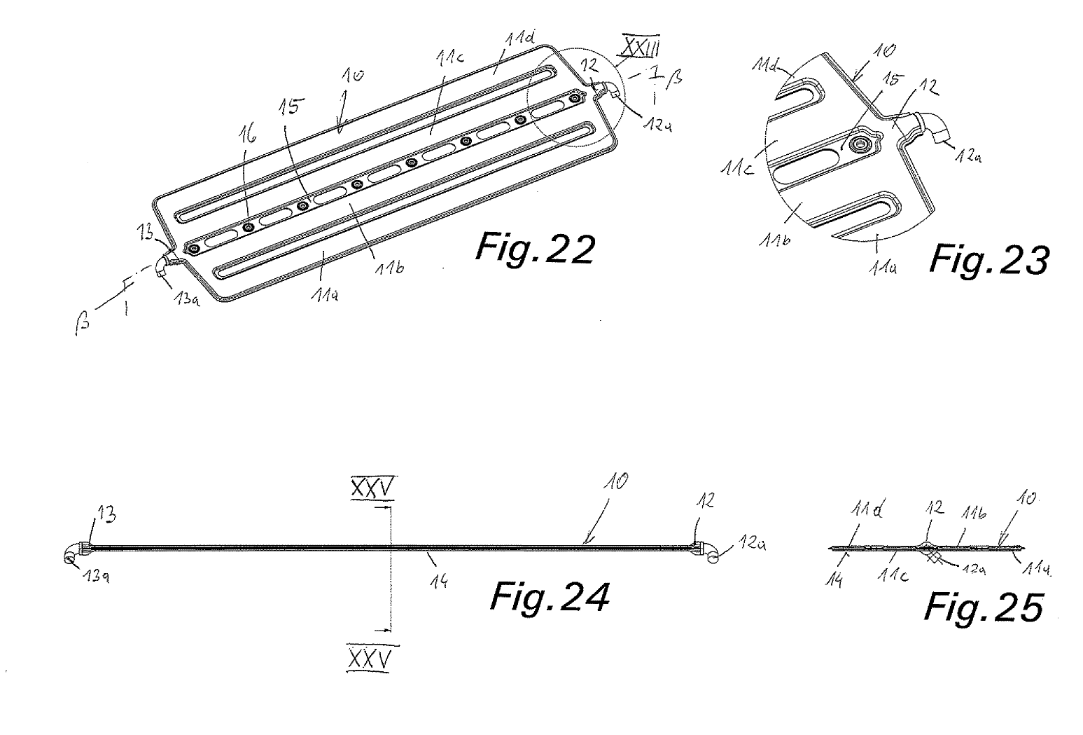

In the embodiment variants illustrated in FIGS. 12 to 25, the heat conduction unit 10 respectively has multiple channels 11a, 11b, 11c, 11d for a gaseous or liquid heat conduction medium, wherein the channels 11a, 11b, 11c, 11d are arranged adjacent to one another and transversely to the cell planes 4′ of the battery cells 4a, 4b. The channels 11a, 11b, 11c, 11d extend between an entry region 12 and an exit region 13 for the heat conduction medium in the direction of the stack 3a, 3b of the battery cells 4a, 4b, wherein the entry and exit regions 12, 13 are arranged in the region of various end faces 1b, 1c of the energy accumulator 1. The channels 11a, 11b, 11c, 11d can have an essentially constant cross section between the entry region 12 and the exit region 13 for the heat conduction medium. On the outer side of the channels 11a, 11b, 11c, 11d, facing toward the battery cells 4a, 4b, of the heat conduction unit 10, the bottom side of the heat conduction unit 10, the flat heat conduction surfaces 14 implemented.

In the case of at least two battery modules 2 arranged one behind another in the stack direction, at least one shared heat conduction unit 10 can be thermally connected to the contact surfaces 8 of the two battery modules 2 and can be implemented for the temperature control of the battery modules 2.

The heat conduction surfaces 14 lie flatly on the contact surfaces 8 of the cell connectors 8a, 8b, 8c, 8d, so that good heat conduction is ensured. The heat conduction surfaces 14 can be inseparably connected to the contact surfaces 8, for example, by gluing. Adhesive points on the contact surfaces 8 are indicated by reference signs 19 in FIG. 10.

Alternatively or additionally thereto, the heat conduction unit 10 can be connected via detachable fastening means, for example, fastening screws, to the battery module 2. For this purpose, the heat conduction unit 10 has, between the two middle channels 11b, 11c, a fastening region 15 for a fastening means preferably formed by fastening screws 16.

In the embodiments of heat conduction units 10 having multiple channels 11a, 11b, 11c, 11d illustrated in FIGS. 12 to 25, the heat conduction unit 10 can respectively be formed by a bottom shell 10a and a top shell 10b, which are inseparably joined together by welding (friction welding, laser welding) or gluing, for example. The heat conduction unit 10 can consist of plastic and can be produced in an extrusion method. However, the heat conduction unit 10 can also consist of metal, for example, aluminum or steel. Suitable electrical insulation to the contact surfaces 8 are to be provided in the case of a metallic material.

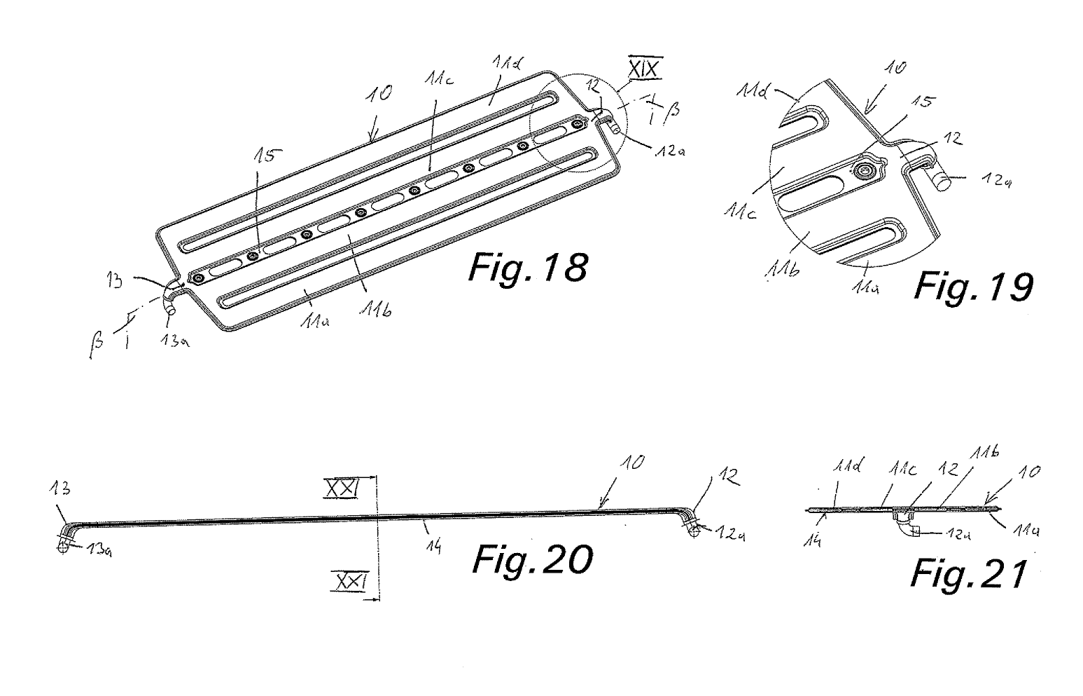

FIGS. 12 to 17 show an embodiment in which the entry and exit regions 12, 13 are arranged on the corners of a long side of the energy accumulator 1. In the example illustrated in FIGS. 18 to 25, in contrast, the entry and exit regions 12, 13 for the heat conduction medium are located in the region of a longitudinal center plane β of the heat conduction unit 10. The embodiments of FIGS. 18 to 21 and FIGS. 22 to 25 essentially only differ by way of the orientation of the connection pipes 12a, 13a at the entry and exit regions 12, 13 of the heat conduction unit 10.

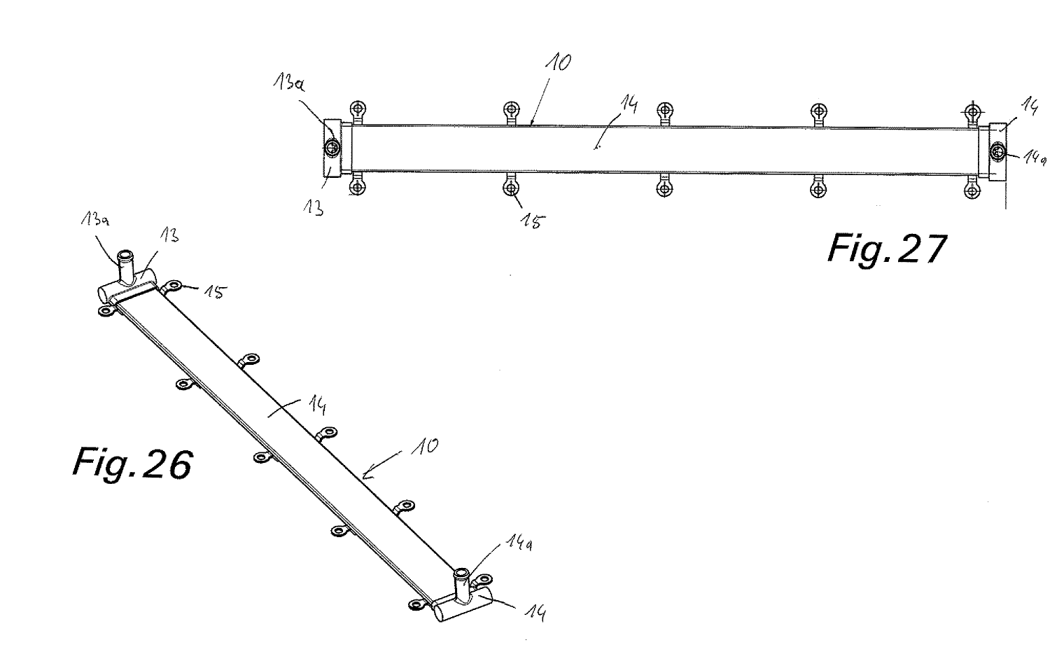

FIGS. 26 and 27 illustrate a further embodiment of an exemplary heat conduction unit 10, which only has a single channel 11, however. The heat conduction unit 10 can be implemented in one piece and, with the exception of corner connectors having those connections in the entry and exit regions 12a, 13a, can be produced in an extrusion operation. The channel 11 extends transversely to the cell planes 4′, 4″ and is arranged above the contact surfaces 8 of a stack 3a, 3b, which lie adjacent to one another in the stack direction 3′. Multiple heat conduction units can be arranged parallel to one another over respectively one group of contact surfaces 8, which are adjacent in the stack direction 3′.

What is claimed is:

1. An electrical energy accumulator (1), in particular for an electric vehicle, which has a plurality of battery cells (4a, 4b), which are electrically connected to one another, and are in particular flat and essentially plate-shaped, and which are arranged in at least one stack (3a, 3b) adjacent to one another or one on top of another, wherein the cell poles (6) of at least two battery cells (4a, 4b), which are electrically interconnected with one another, are connected to one another by at least one cell connector (8a, 8b, 8c, 8d), wherein at least one cell pole (6) and at least one cell connector (8a, 8b, 8c, 8d) are connected to one another, in particular by way of a clinching connection (7), characterized in that at least the cell pole (6) connected to the cell connector (8a, 8b, 8c, 8d) is bent over into a first plane (ε) perpendicularly to the cell plane (4′, 4″) of the battery cells (4a, 4b).

2. The energy accumulator (1) according to claim 1, characterized in that, to connect at least two battery cells (4a, 4b), which are arranged one on top of another along the stack direction (3′), of a stack (3a, 3b), a first cell connector (8a) and a second cell connector (8b) are connected to one another—preferably by a clinching connection (7)—wherein the first cell connector (8a) is connected to a cell pole (6) of one battery cell (4a, 4b) and the second cell connector (8b) is connected to a cell pole (6) of an adjacent battery cell (4a, 4b)—preferably by a further clinching connection (7) in each case.

3. The energy accumulator (1) according to claim 1 or 2, characterized in that, to connect at least two battery modules (2), which are arranged one behind another along the stack direction (3′), of battery cells (4a, 4b), a second cell connector (8b) and a third cell connector (8c) are connected to one another—preferably by a clinching connection (7)—wherein the second cell connector (8b) is connected to a cell pole (6) of one module (2) and the third cell connector (8c) is connected to a cell pole (6) of the adjacent battery module (2)—preferably by a further clinching connection (7) in each case.

4. The energy accumulator (1) according to one of claims 1 to 3, characterized in that, to connect at least two battery cells (4a, 4b) arranged adjacent to one another transversely to the stack direction (3′), a fourth cell connector (4d)—which is preferably implemented as flat—is connected—preferably by a clinching connection (7)—to a cell pole (6) of the battery cell (4a; 4b) of one stack (3a; 3b) and is connected—preferably by a further clinching connection (7)—to a cell pole (6) of the battery cell (4b; 4a) of an adjacent stack (3b; 3a).

5. The energy accumulator (1) according to one of claims 1 to 4, characterized in that—considered in the stack direction (3′)—at least one cell connector, preferably the first, the second, and/or the third cell connector (8a, 8b, 8c), has a first L-shape (8a1, 8b1, 8c1)—which is particularly preferably formed by a bending operation.

6. The energy accumulator (1) according to one of claims 1 to 5, characterized in that—transversely to the stack direction (3′), preferably considered in a top view of the energy accumulator (1)—at least one cell connector, preferably the first and/or third cell connector (8a, 8c), has a second L-shape (8a2, 8c2), wherein particularly preferably the second L-shape (8a2, 8c2) has two legs (8a2′, 8a2″) arranged in a plane.

7. The energy accumulator (1) according to one of claims 1 to 6, characterized in that all cell poles (6) together with the cell connectors (8a, 8b, 8c, 8d) connected thereto, are bent over in the same direction, preferably along the stack direction (3′), so that the top sides of bent-over cell connectors (8a, 8b, 8c, 8d) form contact surfaces (8) essentially arranged in the first plane (ε).

8. The energy accumulator (1) according to claim 7, characterized in that at least one heat conduction unit (10) is placed on the contact surfaces (8) formed by the top sides of the bent-over cell connectors (8a, 8b, 8c, 8d), and is preferably thermally and fixedly connected to the cell connectors (8a, 8b, 8c, 8d), particularly preferably by gluing.

9. The energy accumulator (1) according to claim 8, characterized in that the heat conduction unit (10) has at least one heat conduction surface (14), which faces toward the battery cells (4a, 4b), and is preferably implemented as flat and parallel to the contact surfaces (8), wherein the heat conduction surface (14) is thermally and fixedly connected to the cell connectors (8a, 8b, 8c, 8d).

10. The energy accumulator (1) according to claim 8 or 9, characterized in that the heat conduction unit (10) has at least two, preferably at least four channels (11a, 11b, 11c, 11d) for the heat conduction medium, preferably having flow through them perpendicularly to the cell planes (4′) of the battery cells (4), wherein preferably at least one fastening region (15) is arranged between at least two channels (11b, 11c), for a fastening means formed by fastening screws (16), for example.

11. The energy accumulator (1) according to claim 8 or 9, characterized in that the energy accumulator (1) has multiple heat conduction units (10), wherein each heat conduction unit (10), which is preferably embodied in one piece, has a single channel (11) for flow of the heat conduction unit through it transversely to the battery cells (4a, 4b), preferably perpendicularly to the cell planes (4′) of the battery cells (4), which extends perpendicularly to the cell planes (4′, 4″) over contact surfaces (8) of multiple battery cells (4a, 4b) arranged one behind another in the stack direction (3′).

12. A method for manufacturing an electrical energy accumulator (1), in particular for an electric vehicle, which has a plurality of battery cells (4a, 4b), which are electrically connected to one another, and are in particular flat and essentially plate-shaped, and which are arranged adjacent to one another or one on top of another in at least one stack (3a, 3b), wherein the cell poles (6) of at least two battery cells (4a, 4b), which are electrically interconnected to one another, are connected by at least one cell connector (8a, 8b, 8c, 8d), and wherein at least one cell pole (6) and at least one cell connector (8a, 8b, 8c, 8d) are connected to one another in a joining operation—in particular in a clinching operation—characterized in that after the joining operation, at least the cell pole (6) connected to the cell connector (8a, 8b, 8c, 8d) is bent over in a first plane (ε) perpendicularly to the cell plane (4′, 4″) of the battery cells (4a, 4b).

13. The method according to claim 12, characterized in that, to electrically connect at least two battery cells (4a, 4b), which are arranged one on top of another along the stack direction (3′), of a stack (3a; 3b), a first leg (8a1′) of an L-shaped first cell connector (8a) is connected to a cell pole (6) of one battery cell (4a; 4b) and a first leg (8b1′) of an L-shaped second cell connector (8b) is connected to a cell pole (6) of an adjacent battery cell (4b; 4a) in a joining operation—preferably in a clinching operation (7)—wherein before the joining operation, the cell poles (6) and the first legs (8a1′, 8b1′) are aligned parallel to the cell planes (4′, 4″) and at least partially overlapping one another, and the cell poles (6) together with the cell connectors (8a, 8b) are bent over in the same direction by approximately 90° into a plane (ε) perpendicular to the cell planes (4′, 4″) so that the second legs (8a1″, 8b1″) of the first and second cell connectors (8a, 8b) overlap one another.

14. The method according to claim 13, characterized in that the second legs (8a1″, 8b1″) of the first and second cell connectors (8a, 8b) are connected to one another—preferably in a further clinching operation.

15. The method according to one of claims 12 to 14, characterized in that, for the electrical connection of at least two battery modules (2), which are arranged one on top of another along the stack direction (3′), of battery cells (4a, 4b), a first leg (8c1′) of an L-shaped third cell connector (8c) is connected to a cell pole (6) of one module (2) and a first leg (8b1′) of an L-shaped second cell connector (8b) is connected to a cell pole (6) of an adjacent battery module (2) in a joining operation, preferably a clinching operation, wherein before the joining operation, the cell poles (6) and the first legs (8a1′, 8c1′) are aligned parallel to the cell planes (4a, 4b) and at least partially overlapping one another, and the cell poles (6) including the cell connectors (8b, 8c) are bent over in the same direction by approximately 90° into a plane (ε) perpendicular to the cell planes (4′, 4″), so that the second legs (8c1″, 8b1″) of the third and second cell connectors (8c, 8b) overlap one another.

16. The method according to claim 15, characterized in that the second legs (8c1″, 8b1″) of the third and second cell connectors (8c, 8b) are connected to one another by a further clinching operation.

17. The method according to one of claims 12 to 16, characterized in that, to connect at least two battery cells (4a, 4b), which are arranged adjacent to one another transversely to the stack direction (3′), a fourth cell connector (8d)—which is preferably implemented as flat—is connected in a joining operation, preferably a clinching operation, to a cell pole (6) of the battery cell (4a, 4b) of one stack (3a; 3b) and is connected in a further joining operation—preferably a further clinching operation—to a cell pole (6) of the battery cell (4b; 4a) of an adjacent stack (3b; 3a), wherein before the clinching operation, the cell poles (6) and the fourth cell connector (8d) are aligned parallel to the cell planes (4′, 4″) and at least partially overlapping one another, and the cell poles (6) together with the cell connectors (8d) are bent over in the same direction by approximately 90° into a plane (ε) perpendicular to the cell planes (4′, 4″).

18. The method according to one of claims 12 to 17, characterized in that at least one heat conduction unit (10) is placed on contact surfaces (8) formed by the bent-over cell connectors (8a, 8b, 8c, 8d) and is connected to the cell connectors (8a, 8b, 8c, 8d) in a thermally conductive manner, particularly preferably by gluing.
